(19) United States
(12) Patent Application Publication
(10) Pub. No.: US 2018/0298637 A1
(43) Pub. Date: Oct. 18, 2018

(54) SECURITY GATE LOCKSMITH TOOL

(71) Applicant: Arrie T. Johnson, Parsonburg, MD (US)

(72) Inventor: Arrie T. Johnson, Parsonburg, MD (US)

(21) Appl. No.: 15/949,972

(22) Filed: Apr. 10, 2018

Related U.S. Application Data
(60) Provisional application No. 62/484,883, filed on Apr. 12, 2017.

(51) Int. Cl. E05B 17/22

(52) U.S. Cl. CPC E05B 17/22

(57) ABSTRACT

A security gate locksmith tool is a device designed to attach to a security gate to open the gate when the keys for opening the gate are not available. It has a handle portion that is attached to the outer side of the security gate, a hooked conduit portion attached to the back side of the handle portion in which a flexible wire or cable passes through, and a rigid u-shaped piece attached to the flexible wire that is designed to engage a thumb turn lock located on the back side of the security gate from which the handle portion is located. Turning the handle rotates the flexible wire and therefore the u-shaped piece attached to the end of the flexible wire to turn the thumb turn lock, when engaged with the u-shaped piece, to open the gate.

### CROSS-REFERENCE TO RELATED APPLICATION

The present application is related to and claims priority from prior provisional application Ser. No. 62/484,883, filed Apr. 12, 2017 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of locksmith tools and more specifically relates to a security gate locksmith tool capable of opening a thumb turn lock.

### 2. Description of the Related Art

Security gates are used to prevent the access of unauthorized people into a doorway or other passageway. The restricted areas generally store products, tools, equipment, sensitive records, and other such things to prevent theft that may have the potential to impact the company's financial wellbeing. Security gates are also used to restrict access of personnel to those having certain information, occupations, or skills. Security gates are commonly used in industrial environments, construction areas, retail stores, stadiums, office buildings, and even homes. Commonly, security gates are made of steel or other strong metal materials which make them very difficult to break into. Instances occur when security gate keys are lost and authorized personal are locked out. Because of the nature and design of the doors, they can also be a challenge for a locksmith to gain access to in the event that the authorized personnel loose the keys to the gate. As such, a device to assist a locksmith or other authorized personnel to open a locked security gate is needed.

Various attempts have been made to solve the above-mentioned problems such as those found in U.S. Pat. No. 7,040,203 to George Chistiano; and U.S. Pat. No. 5,540,121 to Kevin D. Helmers. This prior art is representative of latch and door opening locksmith tools. None of the above inventions and patents, taken either singly or in combination, is seen to describe the invention as claimed.

Ideally, a locksmith tool for opening security gates should provide convenience and ease of use while preventing damage, and yet, would operate reliably and be manufactured at a modest expense. Thus, a need exists for a reliable security gate locksmith tool to avoid the above-mentioned problems.

### BRIEF SUMMARY OF THE INVENTION

In view of the foregoing disadvantages inherent in the known locksmith tools art, the present invention provides a novel security gate opening locksmith tool. The general purpose of the present invention, which will be described subsequently in greater detail, is to provide convenience and ease of use while preventing damage to security gates.

A security gate locksmith tool preferably comprises a handle portion including a handle plate member having a front side, a back side, and an aperture therethrough, and a handle member having a handle grip and a handle axle. The handle axle is connected to and extends from the handle grip. The handle axle extends through the aperture of the handle plate member and is rotatably attached thereto. The handle grip is located adjacent the front side of a security gate and the handle axle is located adjacent the back side.

An elongated arm portion having an elongated exterior conduit with a proximal end is attached to the back side of the handle plate member around the aperture, and a distal end extends into a hook through which an elongated flexible wire extends through. The elongated flexible wire includes a proximal end attached to the handle axle of the handle member, and a distal end extends at least the length thereof, and is adapted to rotate therein via the handle member. The elongated flexible wire is located within the elongated exterior conduit and a latch attachment member including an attachment portion is adapted to releasably attach to the distal end of the elongated flexible wire and rotate therewith.

The lock engagement portion extends from the attachment portion and is adapted to releasably engage with and rotate a thumb turn lock of the security gate. The handle portion further includes at least one attachment clip connected to and extending from the back side of the handle plate member and is adapted to releasably attach the handle portion to the security gate. The handle plate member further includes a cylinder member attached to and extending from the back side and around the aperture such that the proximal end of the elongated exterior conduit can attach to the back side of the handle plate member via the cylinder member.

The lock engagement portion of the latch attachment member is U-shaped and adapted to contact outer edges of the thumb turn lock for rotating the thumb turn lock. The lock engagement portion of the latch attachment member is formed as a dead-latch tool adapted to releasably engage and rotate a thumb turn lock of an electromechanical door lock.

There is at least one attachment clip but there may be two attachment clips spaced from one another that are connected to and extend from the back side of the handle plate member that are adapted to releasably attach to the handle portion to the security gate. The attachment clip is U-shaped and adapted to releasably attach the handle portion to the security gate. Each of the two attachment clips are preferably U-shaped and adapted to releasably attach the handle portion to the security gate. The security gate locksmith tool may be formed from a material chosen from a list of materials consisting of aluminum, steel, copper, and ceramic.

The combination of a security gate and a security gate locksmith tool may comprise a security gate having at least one panel member including a thumb turn lock with the panel member(s) adapted to be movable relative to a structural member attached to the gate, a security gate locksmith tool comprising a handle portion including a handle plate member having a front side, a back side and an aperture therethrough, and a handle member including a handle grip and a handle axle. The handle axle is connected to and extends from the handle grip and extends through the aperture of the handle plate member and is rotatably attached thereto. The handle grip is located adjacent to the front side, and the handle axle is located adjacent to the back side. The handle portion is adapted to be placed against the panel member(s) of the security gate.

An elongated arm portion for engagement with the thumb turn lock may have an elongated exterior conduit with a proximal end attached to the back side of the handle plate member around the aperture and having a distal end with an elongated flexible wire extending therethrough. The proximal end of the elongated flexible wire is attached to the handle axle of the handle member and the distal end of the flexible wire extends through the distal end of the elongated exterior conduit. The elongated flexible wire is located within the elongated exterior conduit, extends at least the length thereof, and is adapted to rotate therein via the handle member.

A latch attachment member includes an attachment that is adapted to releasably attach to the distal end of the elongated flexible wire and rotate therewith. A lock engagement portion extends from the attachment portion and is adapted to releasably engage with and rotate the thumb turn lock of at least one panel member of the security gate. The handle portion further includes at least one attachment clip connected to and extending from the back side of the handle plate member and is adapted to releasably attach the handle portion to the panel member(s) of the security gate.

The handle plate member further includes a cylinder member attached to and extending from the back side around the aperture and is adapted such that the proximal end of the elongated exterior conduit can attach to the back side of the handle plate member via the cylinder member. The lock engagement portion of the latch attachment member is U-shaped and is adapted to contact outer edges of the thumb turn lock to thereby rotate the thumb turn lock. The thumb turn lock may be formed as an electromechanical door lock. The lock engagement portion of the latch attachment member may be formed as a dead-latch tool adapted to releasably engage and rotate the electromechanical door lock.

There may be two attachment clip(s) spaced from one another that are connected to and extend from the back side of the handle plate member and are adapted to releasably attach the handle portion to the security gate. There may be one door panel member or there may be two door panel members each adapted to be movable relative to the structural member and to one another. The attachment clip(s) is/are U-shaped and adapted to releasably attach to the handle portion between the two door panel members of the security gate. Each of the two attachment clips are U-shaped and adapted to releasably attach to the handle portion between the two door panel members of the security gate. The security gate locksmith tool is formed from a material chosen from a list of materials consisting of aluminum, steel, copper, and ceramic.

The present invention holds significant improvements and serves as a security gate locksmith tool. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, a security gate locksmith tool, constructed and operative according to the teachings of the present invention.

FIG. 1 shows a perspective view illustrating a security gate locksmith tool according to an embodiment of the present invention.

FIG. 2 is an overhead view illustrating an elongated arm portion of the security gate locksmith tool according to an embodiment of the present invention of FIG. 1.

FIG. 3 is a perspective view illustrating a lock engagement portion of the security gate locksmith tool according to an embodiment of the present invention of FIG. 1.

FIG. 4 is a side view showing the combination of a security gate and a security gate locksmith tool.

The various embodiments of the present invention will hereinafter be described in conjunction with the appended drawings, wherein like designations denote like elements.

### DETAILED DESCRIPTION

As discussed above, embodiments of the present invention relate to locksmith tools and more particularly to a security gate locksmith tool as used to improve the convenience and ease of use while preventing damage to security gates.

Generally speaking, a security gate locksmith tool is a device designed to attach to a security gate to open the gate when the keys for opening the gate are not available. It has a handle portion that is attached to the outer side of the security gate, a hooked conduit portion attached to the back side of the handle portion in which a flexible wire or cable passes through, and a rigid u-shaped piece attached to the flexible wire that is designed to engage a thumb turn lock located on the back side of the security gate from which the handle portion is located. Turning the handle rotates the flexible wire and therefore the u-shaped piece attached to the end of the flexible wire to turn the thumb turn lock, when engaged with the u-shaped piece, to open the gate.

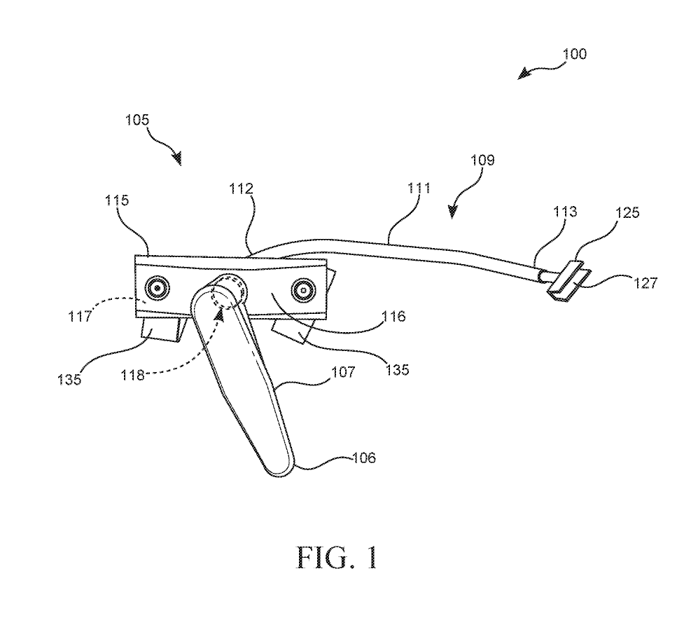

Referring to the drawings by numerals of reference there is shown in FIG. 1, a perspective view illustrating security gate locksmith tool 100 according to an embodiment of the present invention.

Security gate locksmith tool 100 preferably comprises handle portion 105 including handle plate member 115 having front side 116, back side 117, and aperture 118 therethrough, and handle member 106 having handle grip 107 and handle axle 108. Handle axle 108 is connected to and extends from handle grip 107. Handle axle 108 extends through aperture 118 of handle plate member 115 and is rotatably attached thereto. Handle grip 107 is located adjacent front side 116 of security gate 205 and handle axle 108 is located adjacent back side 117.

There is at least one attachment clip 135 but there may be two attachment clips 135 spaced from one another that are connected to and extend from back side 117 of handle plate member 115 that are adapted to releasably attach handle portion 105 to security gate 205. Attachment clip 135 is U-shaped and adapted to releasably attach handle portion 105 to security gate 205. Each of the two attachment clip 135 are preferably U-shaped and adapted to releasably attach handle portion 105 to security gate 205. Security gate locksmith tool 100 may be formed from a material chosen from a list of materials consisting of aluminum, steel, copper, and ceramic.

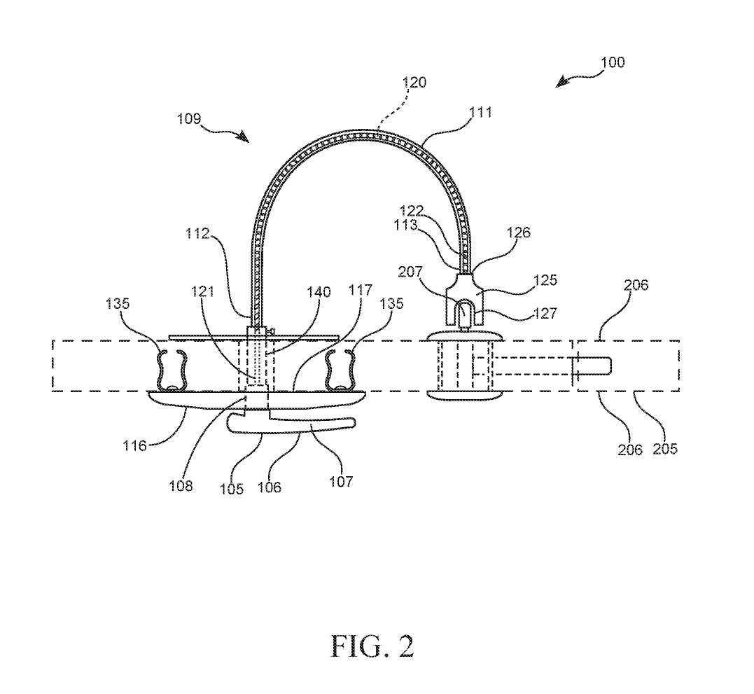

Referring now to FIG. 2, is an overhead view illustrating elongated arm portion 109 of security gate locksmith tool 100 according to an embodiment of the present invention of FIG. 1.

Elongated arm portion 109 having elongated exterior conduit 111 with proximal end 112 is attached to back side 117 of handle plate member 115 around aperture 118, and distal end 113 curves into a hook-shape and through which elongated flexible wire 120 extends through. Elongated flexible wire 120 includes proximal end 121 attached to handle axle 108 of handle member 106, and distal end 122 extends at least the length thereof, and is adapted to rotate therein via handle member 106. Elongated flexible wire 120 is located within elongated exterior conduit 111 and latch attachment member 125 including attachment portion 126 is adapted to releasably attach to distal end 122 of elongated flexible wire 120 and rotate therewith.

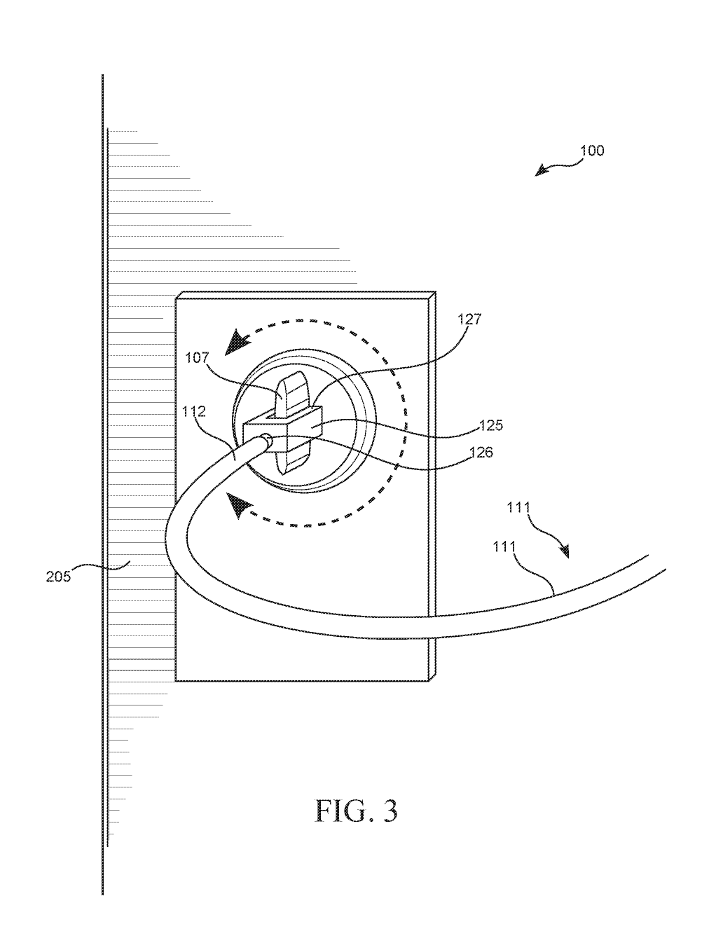

Referring now to FIG. 3, is a perspective view illustrating lock engagement portion 127 of security gate locksmith tool 100 according to an embodiment of the present invention of FIG. 1.

Lock engagement portion 127 extends from attachment portion 126 and is adapted to releasably engage with and rotate thumb turn lock 207 of security gate 205. Handle portion 105 further includes at least one attachment clip 135 connected to and extending from back side 117 of handle plate member 115 and is adapted to releasably attach handle portion 105 to security gate 205. Handle plate member 115 further includes cylinder member 140 attached to and extending from handle plate member 115 and around aperture 118 such that proximal end 112 of elongated exterior conduit 111 can attach to back side 117 of handle plate member 115 via cylinder member 140.

Lock engagement portion 127 of latch attachment member 125 is U-shaped and adapted to contact outer edges of thumb turn lock 207 for rotating thumb turn lock 207. Lock engagement portion 127 of latch attachment member 125 is formed as a dead-latch tool adapted to releasably engage and rotate thumb turn lock 207 of an electromechanical door lock.

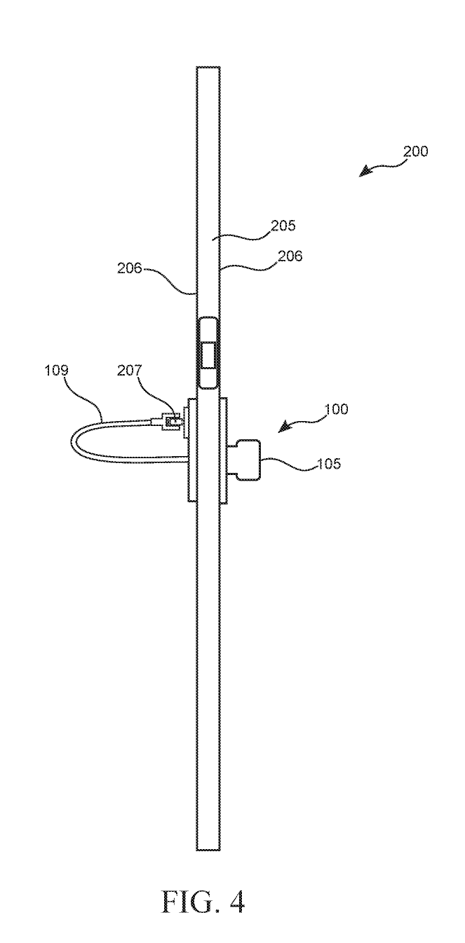

Referring now to FIG. 4, is a perspective view showing combination of a security gate and a security gate locksmith tool 200.

Combination of a security gate and a security gate locksmith tool 200 may comprise security gate 205 having at least one panel member 206 including thumb turn lock 207 with panel member(s) 206 adapted to be movable relative to a structural member attached to security gate 205, security gate locksmith tool 100 comprising handle portion 105 including handle plate member 115 having front side 116, back side 117 and aperture 118 therethrough, and handle member 106 including handle grip 107 and handle axle 108. Handle axle 108 is connected to and extends from handle grip 107 and extends through aperture 118 of handle plate member 115 and is rotatably attached thereto. Handle grip 107 is located adjacent to front side 116, and handle axle 108 is located adjacent to back side 117. Handle portion 105 is adapted to be placed against panel member(s) 206 of security gate 205.

Elongated arm portion 109 for engagement with thumb turn lock 207 may have elongated exterior conduit 111 with proximal end 112 attached to back side 117 of handle plate member 115 around aperture 118 and having distal end 113 with elongated flexible wire 120 extending therethrough. Proximal end 121 of elongated flexible wire 120 is attached to handle axle 108 of handle member 106 and distal end 122 of elongated flexible wire 120 extends through distal end 113 of elongated exterior conduit 111. Elongated flexible wire 120 is located within elongated exterior conduit 111, extends at least the length thereof, and is adapted to rotate therein via handle member 106.

Latch attachment member 125 includes attachment portion 126 that is adapted to releasably attach to distal end 122 of elongated flexible wire 120 and rotate therewith. Lock engagement portion 127 extends from attachment portion 126 and is adapted to releasably engage with and rotate thumb turn lock 207 of at least one panel member(s) 206 of security gate 205. Handle portion 105 further includes at least one attachment clip 135 connected to and extending from back side 117 of handle plate member 115 and is adapted to releasably attach handle portion 105 to panel member(s) 206 of security gate 205.

Handle plate member 115 further includes cylinder member 140 attached to and extending from back side 117 around aperture 118 and is adapted such that proximal end 112 of elongated exterior conduit 111 can attach to back side 117 of handle plate member 115 via cylinder member 140. Lock engagement portion 127 of latch attachment member 125 is u-shaped and is adapted to contact the outer edges of thumb turn lock 207 to thereby rotate thumb turn lock 207. Thumb turn lock 207 may be formed as an electromechanical door lock. Lock engagement portion 127 of latch attachment member 125 may be formed as a dead-latch tool adapted to releasably engage and rotate the electromechanical door lock.

There may be two attachment clip(s) 135 spaced from one another that are connected to and extend from back side 117 of handle plate member 115 and are adapted to releasably attach handle portion 105 to security gate 205. There may be one door panel member(s) 206 or there may be two panel member(s) 206 each adapted to be movable relative to the structural member and to one another. Attachment clip(s) 135 is/are U-shaped and adapted to releasably attach to handle portion 105 between the two door panel member(s) 206 of security gate 205. Each of the two attachment clip(s) 135 are U-shaped and adapted to releasably attach to handle portion 105 between the two door panel member(s) 206 of security gate 205. Security gate locksmith tool 100 is formed from a material chosen from a list of materials consisting of aluminum, steel, copper, and ceramic.

Security gate locksmith tool 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. A security gate locksmith tool comprising:
a handle portion including:
a handle plate member including;
a front side;
a back side; and
an aperture therethrough;
a handle member including:
a handle grip; and
a handle axle;
wherein said handle axle is connected to and extends from said handle grip;
wherein said handle axle extends through said aperture of said handle plate member and is rotatably attached thereto; and
wherein said handle grip is located adjacent said front side, and said handle axle is located adjacent said back side;
wherein said handle portion is adapted to be placed against a security gate;
an elongated arm portion including:
an elongated exterior conduit including:
a proximal end attached to said back side of said handle plate member around said aperture thereof; and
a distal end;
an elongated flexible wire including:
a proximal end attached to said handle axle of said handle member; and
a distal end;
wherein said elongated flexible wire is located within said elongated exterior conduit, extends at least the length thereof, and is adapted to rotate therein via said handle member; and
a latch attachment member including:
an attachment portion;
wherein said attachment portion is adapted to releasably attach to said distal end of said elongated flexible wire and rotate therewith; and
a lock engagement portion;
wherein said lock engagement portion extends from said attachment portion and is adapted to releasably engage with and rotate a thumb turn lock of said security gate.

2. The security gate locksmith tool of claim 1, wherein said handle portion further includes at least one attachment clip connected to and extending from said back side of said handle plate member and adapted to releasably attach said handle portion to said security gate.

3. The security gate locksmith tool of claim 1, wherein said handle plate member further includes a cylinder member attached to and extending from said back side thereof and around said aperture thereof, and adapted such that said proximal end of said elongated exterior conduit can attach to said back side of said handle plate member via said cylinder member.

4. The security gate locksmith tool of claim 1, wherein said lock engagement portion of said latch attachment member is U-shaped and adapted to contact outer edges of said thumb turn lock to thereby rotate said thumb turn lock.

5. The security gate locksmith tool of claim 1, wherein said lock engagement portion of said latch attachment member is formed as a dead-latch tool adapted to releasable engage and rotate a thumb turn lock of an electromechanical door lock.

6. The security gate locksmith tool of claim 2, wherein said at least one attachment clip includes two attachment clips spaced from one another, are connected to and extend from said back side of said handle plate member, and are adapted to releasably attach said handle portion to said security gate.

7. The security gate locksmith tool of claim 2, wherein said at least one attachment clip is U-shaped and adapted to releasably attach said handle portion to said security gate.

8. The security gate locksmith tool of claim 6, wherein each of said two attachment clips are U-shaped and adapted to releasably attach said handle portion to said security gate.

9. The security gate locksmith tool of claim 1, wherein said security gate locksmith tool is formed from a material chosen from a list of materials consisting of aluminum, steel, copper, and ceramic.

10. A combination of a security gate and a security gate locksmith tool, comprising:
a security gate including:
at least one panel member including:
a thumb turn lock;
wherein said at least one panel member is adapted to be movable relative to a structural member attached thereto;
a security gate locksmith tool comprising:
a handle portion including:
a handle plate member including;
a front side;
a back side; and
an aperture therethrough;
a handle member including:
a handle grip; and
a handle axle;
wherein said handle axle is connected to and extends from said handle grip;
wherein said handle axle extends through said aperture of said handle plate member and is rotatably attached thereto; and
wherein said handle grip is located adjacent said front side, and said handle axle is located adjacent said back side;
wherein said handle portion is adapted to be placed against said at least one panel member of said security gate;
an elongated arm portion including:
an elongated exterior conduit including:
a proximal end attached to said back side of said handle plate member around said aperture thereof; and
a distal end;
an elongated flexible wire including:
a proximal end attached to said handle axle of said handle member; and
a distal end;
wherein said elongated flexible wire is located within said elongated exterior conduit, extends at least the length thereof, and is adapted to rotate therein via said handle member; and
a latch attachment member including:
an attachment portion;
wherein said attachment portion is adapted to releasably attach to said distal end of said elongated flexible wire and rotate therewith; and
a lock engagement portion;
wherein said lock engagement portion extends from said attachment portion and is adapted to releasably engage with and rotate said thumb turn lock of said at least one panel member of said security gate.

11. The combination of claim 10, wherein said handle portion further includes at least one attachment clip connected to and extending from said back side of said handle plate member and adapted to releasably attach said handle portion to said at least one panel member of security gate.

12. The combination of claim 10, wherein said handle plate member further includes a cylinder member attached to and extending from said back side thereof and around said aperture thereof, and adapted such that said proximal end of said elongated exterior conduit can attach to said back side of said handle plate member via said cylinder member.

13. The combination of claim 10, wherein said lock engagement portion of said latch attachment member is U-shaped and adapted to contact outer edges of said thumb turn lock to thereby rotate said thumb turn lock.

14. The combination of claim 10, wherein said thumb turn lock is formed as an electromechanical door lock; and said lock engagement portion of said latch attachment member is formed as a dead-latch tool adapted to releasable engage and rotate said electromechanical door lock.

15. The combination of claim 11, wherein said at least one attachment clip includes two attachment clips spaced from one another, are connected to and extend from said back side of said handle plate member, and are adapted to releasably attach said handle portion to said security gate.

16. The combination of claim 10, wherein said at least one door panel member includes two door panel members each adapted to be movable relative to said structural member and to one another.

17. The combination of claim 16, wherein said at least one attachment clip is U-shaped and adapted to releasably attach said handle portion between said two door panel members of said security gate.

18. The combination of claim 15, wherein each of said two attachment clips are U-shaped and adapted to releasably attach said handle portion between said two door panel members of said security gate.

19. The combination of claim 10, wherein said security gate locksmith tool is formed from a material chosen from a list of materials consisting of aluminum, steel, copper, and ceramic.
